(19) United States
(12) Patent Application Publication
(10) Pub. No.: US 2004/0140774 A1
(43) Pub. Date: Jul. 22, 2004

(54) Serial lamp assembly for extending its life of use

(76) Inventor: Mei-Fang Chang, Taipei City (TW)

Correspondence Address: BIRCH STEWART KOLASCH & BIRCH, PO BOX 747, FALLS CHURCH, VA, 22040-0747, US

(21) Appl. No.: 10/347,245

(22) Filed: Jan. 21, 2003

(51) Int. Cl. H05B 39/00

(52) U.S. Cl. 315/185 R; 315/312; 315/185 S; 315/200 R

(57) ABSTRACT

A serial lamp for extending the life of use comprises a power connector at one end of a power cable, and a plurality of light emitting diode (LED) lamps serially connected to the power cable, while a resistor is disposed in front of each LED lamp; characterized in that a rectification diode is disposed in front of the resistor, and the resistor is serially connected to the rectification diode, and a rectification section is formed by sealing with a hard plastic casing, so that a stable electric current can be supplied to the serially connected LED lamps after the current rectification and voltage reduction of an alternating current, and thus improves the life of the serial lamps.

### BACKGROUND OF THE INVENTION

1. Field of the Invention

The present invention relates to a serial lamp assembly for extending its life of use, more particularly to a serial lamp having a rectification section on a power cable, and a rectification section is comprised of a rectification diode and a resisted serially connected to each other, such that the alternating current can be rectified (and converted into direct current) to supply stable voltage and current to the serial LED lamps in order to improve the life of the lamps. Since the rectification section is sealed and packaged by a plastic casing, therefore it gives a moisture-proof effect.

2. Description of the Related Art

A serial lamp is a dazzling decoration, from the original Christmas decoration lamps to the decoration for buildings and ornament for trees on the roads and in the gardens, which gradually becomes a popular cozy nighttime decoration. However, the present power saving and moisture-proof issues have been taken into consideration, most serial lamps are changed from small colored light bulbs to various colored light emitting diode (LED) lamps. Although the LED has various colors, not all of their operating voltages are the same. For example, the white light LED is applicable for a voltage of 4V, but the red light is applicable for a voltage of 2V. Therefore different colored LEDs use different voltages, and the colors of some serially connected lamps are darker and some are brighter. To make the darker ones not too dark, a maximum current in a specific allowable safety range is used, and thus generally shortens the life and burns out some of the LED lamps. The aforementioned prior art structure is shown in FIG. 4. A lamp control box 70, a resistor 80, and a plurality of serially connected lamps 90 are installed behind the power connector 91; wherein the purpose of installing the control box 70 is to control the brightness and blinking of the serial lamps 90. However, there is no rectification measure in the entire serially connected lamps, therefore after the alternating current is connected, it will cause damages to some serial lamps 90 when the voltage is not stable. Since the installation of the LED lamp 90 is inconvenient, it results that the entire set of lamps is unable to use and becomes a waste. These are the main shortcomings of the prior art.

### SUMMARY OF THE INVENTION

The primary objective of the present invention is to provide a serial lamp assembly by serially connecting a rectification diode in front of a resistor, and sealing and packing the rectification diode and the resistor with a plastic casing to attain the moisture-proof effect. In the meantime, the serial lamp assembly further has the functions of rectifying current, regulating voltage, and restricting excessively large current to pass through the lamps, timely protecting the lamps, extending their life, and overcoming the shortcomings of the prior art.

To accomplish the foregoing objective, the present invention comprises a power connector at one end of a power cable of a serial lamp assembly; a plurality of LED lamps serially connected to the power cable; a resistor installed in front of the plurality of the LED lamps; wherein a rectification diode is disposed in front of the resistor, such that the resistor and the rectification diode are serially connected; a plastic casing seals and packages the rectification diode and the resistor to form a rectification section, so that the positive wave can be obtained and the negative wave can be eliminated after the alternating current passes through the rectification section, and then the current is regulated to an appropriate voltage and connected to a series of serially connected LED lamps to stabilize the voltage and current that pass through the entire series of lamps and as a result to improve their life. Furthermore, the rectification section is packaged and sealed by a plastic casing, which also gives a moisture-proof effect for the present invention.

A lamp control box could be installed in front of the rectification section of the power cable of the present invention, so that the lamp may have various blinking, which provides another effect to the embodiment of the present invention.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of a structure in accordance with the present invention.

FIG. 2 is an illustrative diagram of part of the planar structure of the present invention

FIG. 3 is a diagram of a preferred embodiment of the present invention.

FIG. 4 is an illustrative diagram of a prior art structure.

### DETAILED DESCRIPTION OF THE PREFERRED EMBODIMENTS

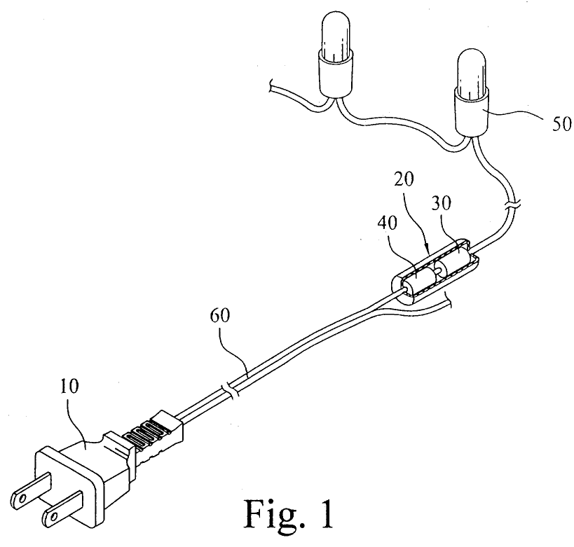

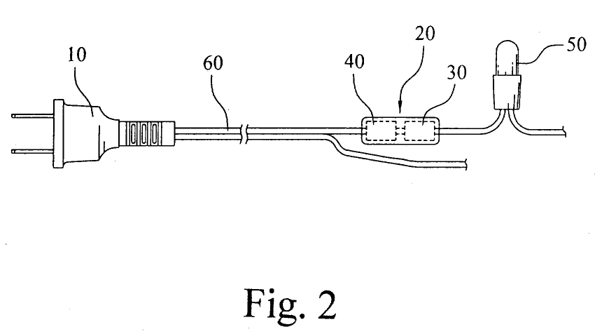

Please refer to FIGS. 1 and 2. The serial lamp of the present invention comprises a power cable 60 with appropriate length; a power connector 10 disposed at one end of the power cable 60; a plurality of different colored LED lamps 50 serially connected to the power cable 60; a resistor 30 installed in front of each LED lamp 50; characterized in that a rectification diode 40 is installed in front of each resistor 30 such that the resistor 30 and the rectification diode 40 are serially connected to each other, and then a plastic casing is used to package and form a rectification section 20, so that the rectification section 20 not just attains the moisture-proof effect, but also provides a stable current to the serial LED lamps 50 after the current rectification and voltage regulation of the alternating current in order to improve the life of serial lamps.

When the alternating current connected to the power connector 10 passes through the rectification diode 40 in the rectification section 20, the positive wave can be obtained and the negative wave can be eliminated, and the resistor 30 can restrict excessively large current and regulate the current with appropriate voltage, so that the series of lamps on the power cable obtains a stable voltage and appropriate current. Thus, the present invention improves the life of the lamps, and provides a moisture effect as well.

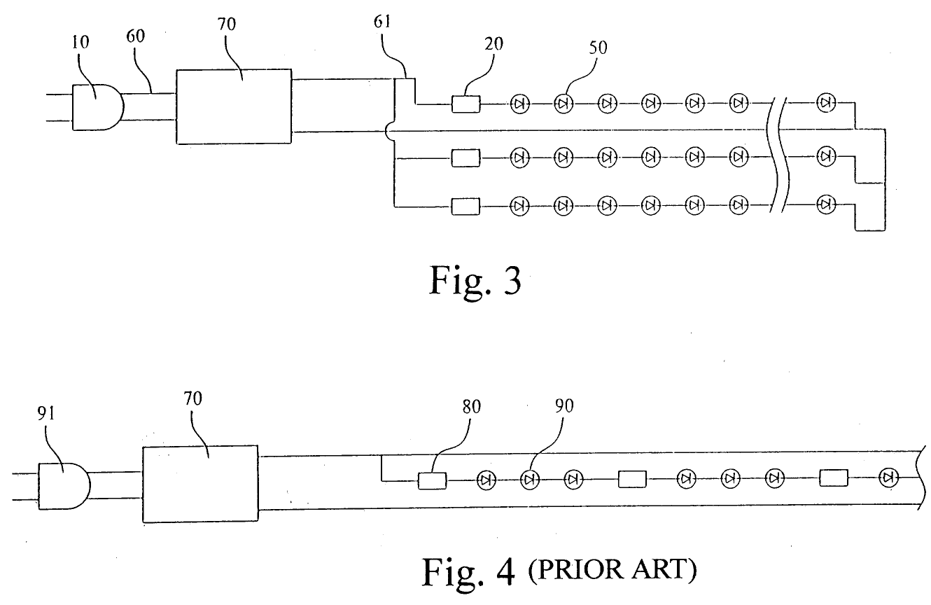

Please refer to FIG. 3 for the power cable of the present invention, which serially connects a light blinking control box 70, and a plurality of electric wires 61 behind the control box 70. The electric wires 61 separately connect to a plurality of different colored LED lamps 50 so that the series of the LED lamps 50 gives a variation of blinking.

Since the present invention possesses the aforementioned features, therefore it has the following advantages on its application:

1. The present invention mainly adds a rectification diode and a resistor to the power cable; after the alternating current passes the rectification diode, the positive half cycle of the alternating current can then pass through the diode, but not the negative half cycle. The power supply of the negative half cycle is cut off from the rectification diode to prevent the LED lamps from being burned under the condition of unstable current. The resistor is a current restricting device for restricting the flow of current through the lamps, therefore both of the rectification diode and the resistor work together to assure the protection of the LED lamps from being damaged, and improve the life of use.

2. The present invention totally seals the rectification section and the resistor with a plastic casing to constitute a rectification section in order to provide a moisture-proof effect and prevent the device from being damaged.

In summation of the above description, the present invention herein enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A serial lamp assembly for extending life of use, comprising:
a power connector, disposed at one end of a power cable:
a plurality of light emitting (LED) lamps, serially connected on the power cable; and a resistor, installed in front of each LED lamp; characterized in that:
a rectification diode being installed in front of the resistor, such that the resistor and the rectification diode being serially connected, and a plastic casing sealing and packaging the rectification diode and the resistor to form a rectification section such that after an alternating current being rectified and the voltage reduced, a stable current being supplied to the serial lamps to improve the life of use of the serial lamps.

2. The serial lamp assembly for extending life of use as cited in claim 1, wherein said power cable has s light control box.
